(19) United States
(12) Patent Application Publication
(10) Pub. No.: US 2018/0248850 A1
(43) Pub. Date: Aug. 30, 2018

(54) TCP SPLICE OPTIMIZATIONS TO SUPPORT SECURE, HIGH THROUGHPUT, NETWORK CONNECTIONS

(71) Applicant: Qualcomm Technologies Inc., San Diego, CA (US)

(72) Inventors: Justin Tee, Irvine, CA (US); Rohit Tripathi, La Jolla, CA (US); Siddharth Gupta, San Diego, CA (US)

(21) Appl. No.: 15/805,409

(22) Filed: Nov. 7, 2017

Related U.S. Application Data
(60) Provisional application No. 62/464,767, filed on Feb. 28, 2017.

(51) Int. Cl. H04L 29/06; H04L 29/08

(52) U.S. Cl. CPC H04L 63/0281; H04L 63/166; H04L 69/167; H04L 67/28; H04L 69/162; H04L 67/42

(57) ABSTRACT

A communication device and method of operating the same. The method may include initiating a first connection between a client device and a proxy server application and a second connection between the proxy server application and the remote server while advertising a proxy-window-scale-value, and splicing the TCP connections below a transport layer. The method also includes left shifting a window size of a client-sourced-packet to obtain an originally intended client-window size, right shifting the originally intended client-window size by the proxy-window-scale-value, and providing the client-sourced-packet to the server with the proxy-window scaled value. In addition, the method includes receiving a server-sourced-packet from the remote server, left shifting a window size of the server-sourced-packet by the server-window-scale value to obtain an originally intended server-window size, right shifting the originally intended server-window size by the proxy-window-scale-value, and then providing the server-sourced-packet to the client with the proxy-window scaled value.

### CLAIM OF PRIORITY UNDER 35 U.S.C. § 119

The present application for patent claims priority to Provisional Application No. 62/464,767 entitled “TCP SPLICE OPTIMIZATIONS TO SUPPORT SOCKSV5 IN LONG FAT NETWORKS” filed Feb. 28, 2017, and assigned to the assignee hereof and hereby expressly incorporated by reference herein.

### BACKGROUND

### Field

The present invention relates to computing devices. In particular, but not by way of limitation, the present invention relates to apparatus and methods for improving network connections between computing devices.

### Background

The automotive industry is quickly integrating with wireless connectivity to begin production of connected cars. As a result, there is the necessity to securely connect from within a car's internal access point to the global Internet without risk of exposing the identity of the car's local area network (LAN) clients. One solution to ensure security is to deploy a socket secure (e.g., SOCKSv5) proxy server on a modem of the access point, which will expose a single public IPv4 address instead of clients' IPv6 global addresses. SOCKSv5 is already developed in RFC (request for comments) 1928, but its architecture poses fundamental issues with respect to performance and network throughput in embedded systems.

Specifically, the SOCKSv5 protocol calls for relaying data payloads from one transmission control protocol (TCP) session to another TCP session, which can consume a majority of a CPU's utilization. The main CPU-utilization bottleneck stems from prior open source implementations of SOCKSv5, where packets travel up the entire kernel networking stack up to the application layer in user space followed by an unnecessary copying of the packet's data payload into the write buffer of an outgoing's socket only to have the same data payload travel all the way back down the kernel networking stack again causing unnecessary overhead for data payload transmissions to proxy clients and remote web servers.

Given that a SOCKSv5 proxy server's duties are to relay data payloads between two TCP sessions, there arises the need for techniques to optimize the traditional TCP/IP network stack for improving throughput and performance over SOCKSv5 protocol.

### SUMMARY

According to an aspect, a communication device is disclosed that includes a first transceiver configured to communicate with a client device via a local area network and a second transceiver configured to communicate with a remote server via a wide area network. A proxy server application is configured to advertise two proxy-window-scale-values while initiating two secure TCP connections that include a first connection between the client device and the communication device and a second connection between the communication device and the remote server. The communication device also includes a TCP splice module that is configured to splice the two TCP connections and relay data between the client device and the remote server in an accelerated manner. The TCP splice module includes a window scaling component configured to left shift a window size of a client-sourced-packet by the client-window-scale value to obtain an originally intended client-window size, and then right shift the originally intended client-window size by an advertised proxy-window-scale-value before relaying the client-sourced-packet to the remote server with a newly calculated proxy-window size value. The TCP splice module is also configured to receive a server-sourced-packet from the remote server, left shift the window size of the server-sourced-packet by the server-window-scale value to obtain an originally intended server-window size, and then right shift the originally intended server-window size by an advertised proxy-window-scale-value, and relay the server-sourced-packet to the client with a newly calculated proxy-window size value.

According to another aspect, a method includes initiating a first connection between a client device and a proxy server application and a second connection between the proxy server application and the remote server while advertising a proxy-window-scale-value, and splicing the TCP connections below a transport layer. The method also includes left shifting a window size of a client-sourced-packet to obtain an originally intended client-window size, right shifting the originally intended client-window size by the proxy-window-scale-value, and providing the client-sourced-packet to the server with the proxy-window scale value. In addition, the method includes receiving a server-sourced-packet from the remote server, left shifting a window size of the server-sourced-packet by the server-window-scale value to obtain an originally intended server-window size, right shifting the originally intended server-window size by the proxy-window-scale-value, and then providing the server-sourced-packet to the client with the proxy-window scale value.

### BRIEF DESCRIPTION OF THE DRAWINGS

FIG. 1 is a diagram depicting an environment in which aspects of the invention may be implemented;

FIG. 2 is a block diagram depicting an exemplary implementation of the proxy device depicted in FIG. 1;

FIG. 3 is a block diagram depicting aspects of an exemplary window size splicer depicted in FIG. 2;

FIG. 4 is a flowchart depicting a method that may be traversed in connection with the window size splicer;

FIG. 5 is a diagram depicting two TCP connections and exemplary aspects of window scaling; and

FIG. 6 is a diagram depicting a location of a TCP splice link relative to layers of a protocol stack;

FIG. 7 is a block diagram depicting components that may be used to realize the client devices, proxy devices, and remote servers described herein.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Aspects disclosed herein relate to improved aspects of TCP splicing, which is a technique to splice two TCP connections so that data being relayed between the two connections can be run at, or near, router speeds.

Beneficially, TCP connections may be carried out via an all-kernel data path to minimize traveling up the kernel networking stack (See, e.g., David A. Maltz and Pravin Bhagwat. 2000, TCP splice application layer proxy performance, J. High Speed Netw. 8, 3 (January 2000), 225-240)), which is incorporated herein by reference. However, the above-referenced Maltz et al. reference does not fully exploit the window scaling TCP option detailed in RFC 7323's TCP Extensions for High Performance [https://tools.ietf.org/html/rfc7323], which is incorporated herein by reference, and lacks discussion on how to properly cleanup/close allocated sockets when spliced TCP sessions receive FIN or RST flags. Although Maltz et al. discusses handling window scaling and selective acknowledgement (SACK) TCP options, the open source implementation of TCP splice [http://www.linuxvirtualserver.org/software/tcpsp/], which is incorporated herein by reference, is flawed in that it does not implement splicing window scale and SACK TCP options, missing opportunities to fully exploit the intent of RFC 7323.

Due to the aforementioned deficiencies, a modified version of TCP splice is disclosed herein, aspects of which support SOCKSv5 protocol and handle TCP options outlined in RFC 7323. Other aspects disclosed herein gracefully handle the closing of sockets when finish (FIN) or reset (RST) packets are observed in spliced TCP sessions.

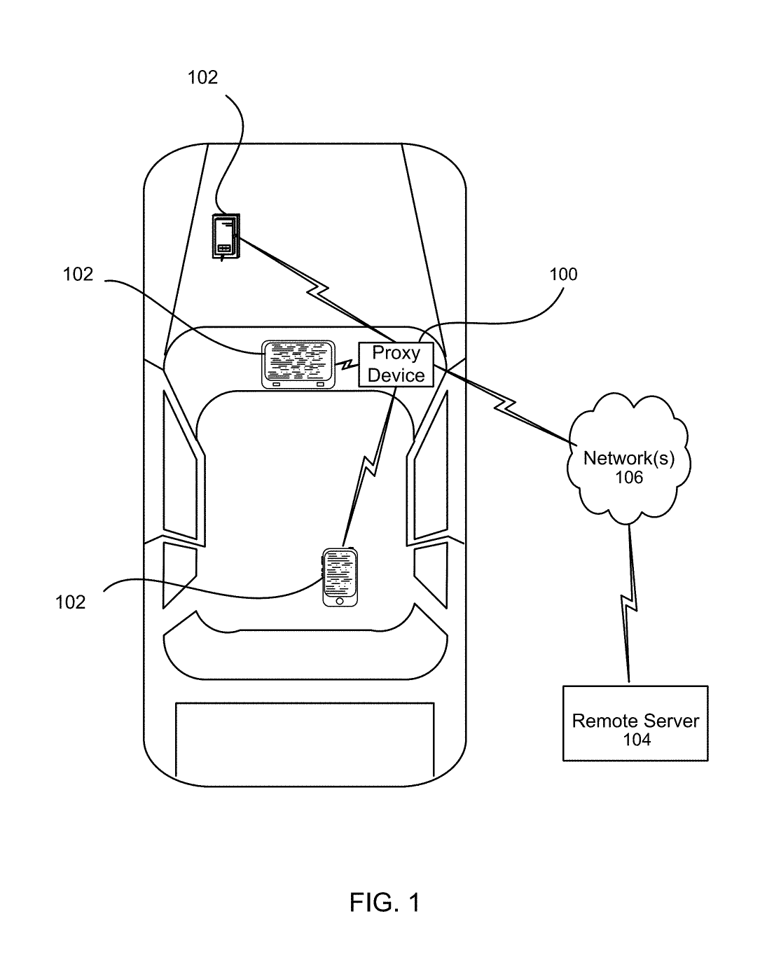

Referring to FIG. 1, shown is a diagram depicting an environment in which aspects of the present invention may be implemented. Shown in FIG. 1 is an automobile that includes a proxy device 100 and client devices 102, that are communicatively coupled to a remote server 104 via a network 106. Each client device 102 may be realized by a variety of different types of devices such as smartphones, infotainment systems, netbooks, laptops, and devices that may be characterized as internet of things (IoT) devices. Each of the client devices 102 may be wirelessly or wireline coupled to the proxy device 100 by a local area network (LAN)(e.g., an ethernet connection), and the network 106 may include one or more wireless networks (e.g., a long term evolution (LTE) network) to couple the proxy device 102 to the remote server 104.

The proxy device 100 may operate in accord with a socket secure protocol (e.g., SOCKSv5 protocol) while providing improved TCP splicing between the client devices 102 and the remote server 104. Although the client devices 102 may expose global addresses consistent with one internet protocol (IP) protocol (e.g., IPv6), the proxy device 100 securely isolates the client devices 102 from other devices, such as the remote server 104, by exposing a single public address (e.g., an IPv4 address). Moreover, the proxy device 100 is configured, as discussed further herein, to enable improved TCP splicing.

As more automotive companies reach out for wireless connectivity, automotive companies will be concerned with the security of their internal networking devices. The proxy device 100 depicted in FIG. 1, and described further herein, provides substantial improvements over prior, naïve implementations of SOCKSv5.

### Splicing Window Sizes (TCP Option-Window Scaling)

In order for peak TCP throughput to be achieved on a link, a TCP transmitter will ideally fill the link's capacity with as much data as physically possible, while waiting for acknowledgements (ACKs), before sending the next sequence of data payload. With high bandwidth delay product links, including links commonly referred to as long fat networks (LFN), poor TCP splice implementation of window sizes will cause the links to suffer from low performance and throughput (e.g., by limiting window sizes to the standard maximum default of 64 KB). This causes the TCP transmitter to delay sending its next sequence of data payloads longer due to the combination of waiting for acknowledgments (ACKs) and long round-trip delay time (RTT).

For example, in prior art SOCKSv5 proxy servers, a window scale value of 0 (corresponding to a maximum default 64 KB window) may be set relative to any client node which connects to it. And when the proxy device makes a proxy-server connection, it propagates the client node's proposed window scale option to a remote server, and if the remote server supports the option, the remote server will be able to send data to the client using the client's scaled window. But problematically, the client will believe the server only supports the default 64 KB window. Moreover, if the server does not support the client node's proposed window scale option, the proxy device must unscale the client's advertised receive window when relaying packets to the server. By forcing the SOCKSv5 proxy server to have a window scale value of 0, efficient utilization of LFNs is lost due to the proxy server's advertisements of window sizes that will never be greater than 64 KB to the proxy client.

In contrast, the proxy device 100 depicted in FIG. 1 (and detailed by way of exemplary embodiments detailed further herein) implements a much-improved approach to TCP spliced window scaling that allows the transmission of larger data payload chunks, after each RTT and returning ACK, thereby increasing a fuller utilization of the communication links and resulting in higher observed throughput.

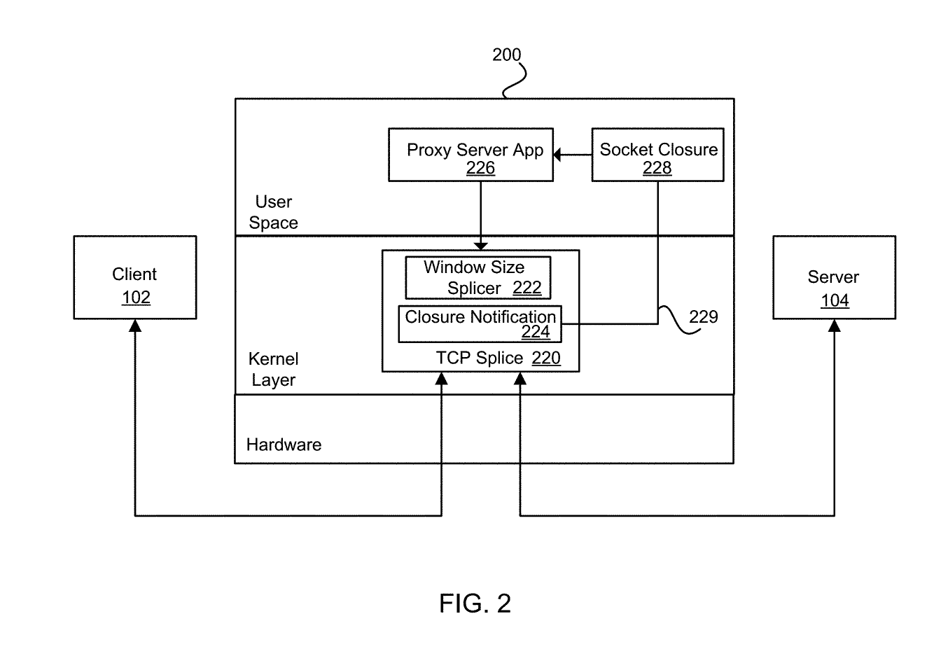

Referring to FIG. 2 for example, shown is a block diagram depicting aspects of an exemplary proxy device 200 that is an example of the proxy device 100 depicted in FIG. 1. As shown, the proxy device 200 includes a TCP splice module 220 in a kernel level of the proxy device 200 that is in communication with the client device 102 and remote server 104. The depicted TCP splice module 220 includes a window size splicer 222 and a closure notification module 224. As shown, the proxy device 200 also includes a proxy server app 226 and a socket closure module 228, which is coupled to the closure notification module 224 and the proxy server app 226.

As shown in FIG. 2, the proxy server app 226 may be implemented as a user-space application, and in operation, the proxy server app 226 performs handshake operations (e.g., SOCKSv5 handshaking) with the client device 102 and makes a connection with the remote server 104. After making connections with the client device 102 and the remote server 104, the proxy server app 226 hands off TCP splice information to the TCP splice module 220 (e.g., via a custom call: setsockopt(SO_TCP_SPLICE)). In many implementations, the TCP splice module 220 is realized by modifications to a LINUX kernel to include the window size splicer 222 and a closure notification module 224 to enable the methodologies disclosed herein. In operation, the TCP splice module 220 may register at Netfilter hooks including preroute (destination network address translation ((DNAT)); forward (TCP splice), and postroute (source network address translation ((SNAT)).

As one of ordinary skill in the art will appreciate, Netfilter is a framework provided by the LINUX kernel that allows various networking-related operations to be implemented in the form of customized handlers. Netfilter allows for custom implementation of functions and operations for packet filtering, network address translation, and port translation, which provide the functionality required for directing packets from the client device 102 to the remote server 104, as well as for providing the ability to prohibit packets from reaching the client device 102. Although it is contemplated that the TCP splicing aspects disclosed herein may be implemented in connection with other operating systems and kernel level systems, for ease of explanation, implementations are described herein in the context of a LINUX operating system.

In the context of a LINUX operating system, Netfilter represents a set of hooks inside LINUX kernel, which allow the TCP splice module 220 to register callback functions with the kernel's networking stack. Those functions, usually applied to traffic in the form of filtering and modification rules, are called for every packet that traverses the respective hook within the networking stack.

The TCP splice module 220 may register for setsockopt(SO_TCP_SPLICE) callback; listen for Netlink messages from the process identification number (PID) of the proxy server app 226; splice valid pairs of TCP sockets stored in a hash table of struct tcp_splice_tuple's; and notify the socket closure module 228 (through Netlink messages) when a finish (FIN) flag is observed to signal to the socket closure module 228 that client and remote server sockets should be closed.

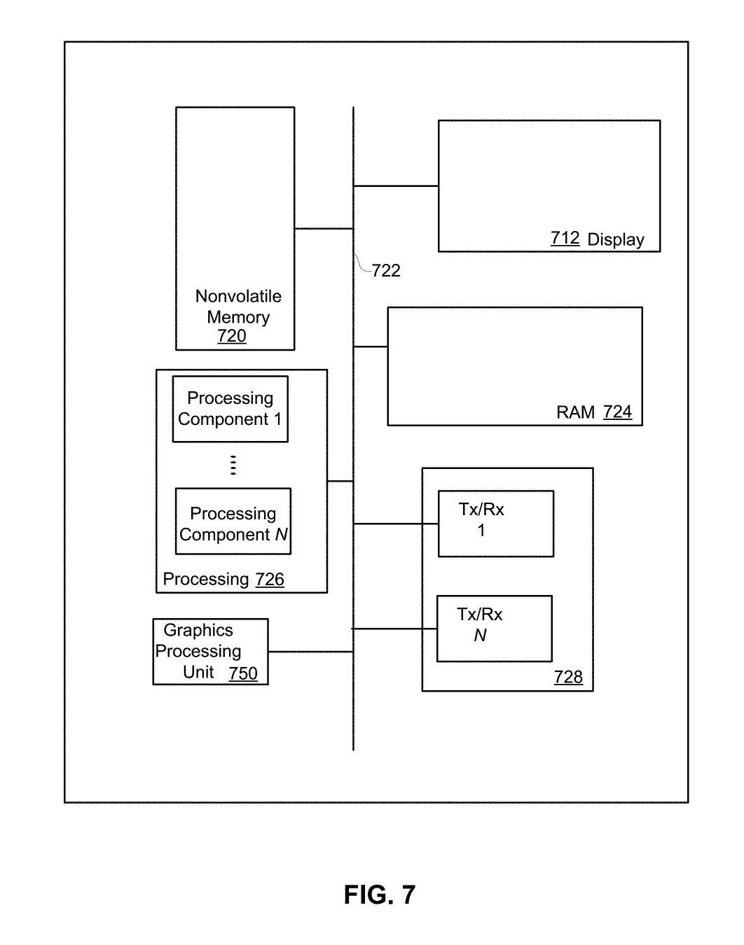

The proxy server app 226 generally operates to initiate a secure connection between the client device 102 and the proxy device 200 and another secure connection between the server 104 and the proxy device 200, and these two connections may be in accord with the SOCKSv5 protocol. As shown, the proxy server app 226 is in communication with the TCP splice module 220 to prompt the TCP splice module 220 to splice the two connections together at the kernel layer. And the socket closure module 228 is configured to prompt, in response to a closure notification signal 229 from the closure notification module 224, the socket closure module 228 to communicate with the proxy server app 226 to close the connections. Also shown in the proxy device 200 is a hardware layer, and exemplary components of the hardware layer of the proxy device 200 are described further herein with reference to FIG. 7. Although many examples disclosed herein are in the context of the SOCKSv5 protocol, it is contemplated that the proxy device 200 may operate consistent with other protocols (including yet to be developed protocols).

In contrast to prior art approaches, the TCP splice module 220 allows the SOCKSv5 proxy server to freely advertise a window scale of whatever desired value (e.g., as allowed by RFC 7323) permitting window sizes greater than 64 KB as is RFC 7323's original intention for LFNs.

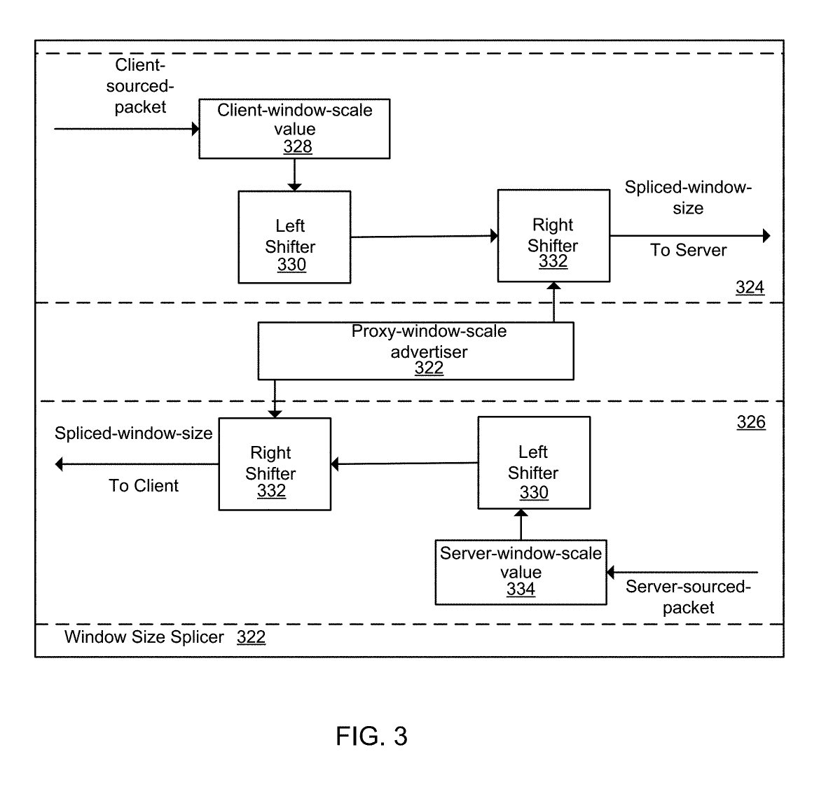

Referring next to FIG. 3, shown is a block diagram depicting a window size splicer 322 that may be implemented to realize the window size splicer 222 depicted in FIG. 2. As shown, the window size splicer 322 includes a proxy-window-scale advertiser 322 and a first portion 324 that receives client-sourced packets from a client device 102 and provides the client-sourced packets to the server 104. In addition, a second portion 326 of the window size splicer 322 receives server-sourced packets and provides the server-sourced packets to the client 102.

The first portion 324 of the window size splicer 322 includes a client-window-scale value module 328, a left shifter 330, and a right shifter 332. And the second portion 326 of the window size splicer 322 includes a server-window-scale value module 334, a left shifter 330, and a right shifter 332. As shown, the right shifter of each of the first portion 324 and the second portion 326 is coupled to the proxy-window-scale advertiser 322.

The components depicted in FIG. 3 are logical to illustrate functional components of the window size splicer 322, and it is anticipated that actual implementations may distribute the functions among multiple components and/or consolidate two or more of the functions to be implemented in a unitary component. For example, it is contemplated that the right shifter 332 depicted as being implemented in both the first portion 324 and the second portion 326 of FIG. 3 could be realized by a single construct that is utilized by both, the first portion 324 and the second portion 326. Moreover, the components depicted in FIG. 3 may be realized by hardware, firmware, software or a combination thereof.

Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted in FIG. 3.

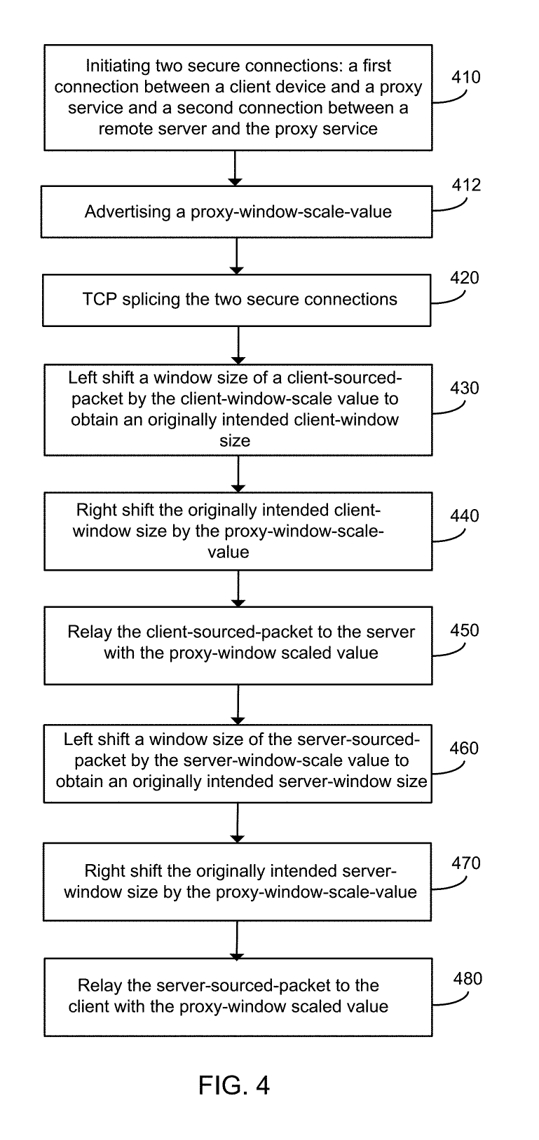

While referring to FIG. 3, simultaneous reference is made to FIG. 4, which is a flowchart depicting a method that may be traversed in connection with the embodiments disclosed herein. As shown, the proxy-server app 226 initiates two secure connections: a first logical connection between the client device 102 and the proxy device 100 and a second logical connection between the client device 100 and the remote server 104 (Block 410). In addition, a proxy-window scale value is advertised (e.g., by the proxy server app 226) to the client device 102 and the remote server 104 (e.g., during initial TCP handshaking between the proxy device 200 and the client device 102 and the remote server)(Block 412). The advertised window scaling value is in the TCP header's TCP options field of the SYN packet during an initial TCP 3-way handshake. Subsequent packets in the spliced TCP session will not have the advertised window scaling value. The window size value is present in the TCP header for all packets, including the initial SYN packet exchange during an initial TCP 3-way handshake. In addition, the proxy server app 226 prompts the TCP splice module 222 to TCP splice the two connections (e.g., at a layer below a transport layer)(Block 420).

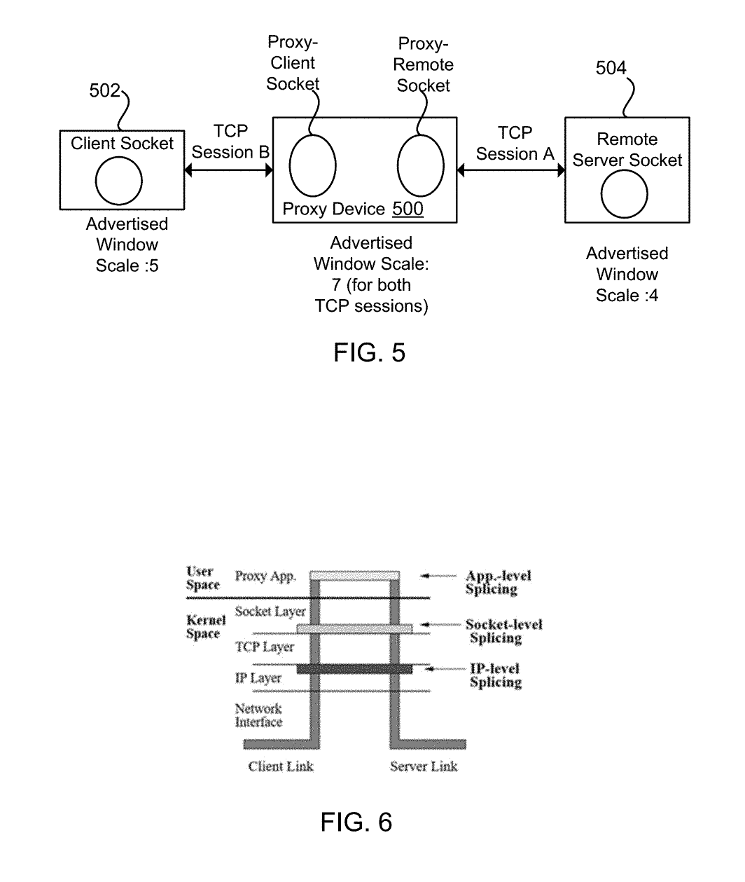

Referring briefly to FIG. 5, shown are two secure TCP sessions: TCP session A between a remote server 504 and a proxy device 500 and TCP session B between a client device 502 and the proxy device 500. And FIG. 6 depicts a splicing of the two secure TCP connections at an IP-level (below the transport layer). FIG. 6 also shows less efficient splicing an app level and at a socket-level.

When a client-sourced packet is received, the client-window-scale value module 328 provides a window-scale value that is advertised by the client device 102 to the left shifter 330. The left shifter 330 left shifts a window size of the client-sourced-packet to obtain the originally intended client-window size (Block 430), and then the right shifter 332 right shifts the originally intended client-window size by the proxy-window-scale-value (Block 440). The client-sourced-packet is then relayed to the server with the proxy-window scaled value (Block 450).

When receiving a server-sourced packet, a window size of the server-sourced-packet is left shifted by the server-window-scale value to obtain an originally intended server-window size (Block 460), and the originally intended server-window size is right shifted by the proxy-window-scale-value (Block 470). The server-sourced-packet is then relayed to the client with the proxy-window scale value (Block 480). As a result, a more accurate window size portrayal on both TCP sessions is provided to enable higher throughput between the client 102 and the remote server 104.

Referring again to FIG. 5, shown is a depiction of how the window size splicer 322 splices window sizes between two TCP sessions according to the method depicted in FIG. 4. In this example, the proxy device 500 hosts a SOCKSv5 proxy app that advertises a window scale of 7. Consistent with Block 430 of FIG. 4, when mapping a window size value from TCP session A to another TCP session B, the receiving packets' window size is first left shifted equal to the negotiated window scale option amount advertised by the non-proxy socket in TCP session A, which effectively obtains the intended window size for the SOCKSv5 proxy server. Then, consistent with Block 440, the window size intended for the proxy server's outgoing socket connected to TCP session B is spliced by right shifting the previously derived effective window size the amount of the proxy server's advertised window scaling value on TCP session B.

In the example depicted in FIG. 5, a client socket advertises a window scale value of 5 during its TCP handshake with the SOCKSv5 proxy service of the proxy device 500, and a remote web server 504 advertises a window scale value of 4 during its TCP handshake with the SOCKSv5 proxy service.

A prior art proxy service (e.g., following the proposal of Maltz el al.), would advertise a window scale value of 0 to the client device 502, and propagate the client's window scale value of 5 to the remote server socket. Continuing with a description of the prior art, assume a packet that is sourced from the socket of the remote web server 504 with a window size value of 0x00a5 is sent to the SOCKSv5 proxy for relaying to the client socket. When the prior art proxy receives the packet from the remote server socket, the same window size specified in the packet is relayed to the client through the proxy-client socket. Upon receiving the packet with window size value of 0x00a5, the client socket would perform window scaling with the proxy's advertised window scale value of 0. This leads the client to think the actual window size of the remote web server socket is 0x00a5<<0=0x00a5=165 bytes. But the remote server socket advertised a window scaling value of 4 to the proxy, and the remote server socket's true window size is actually 0x00a5<<4=0x0a50=2,640 bytes. The discrepancy of intended window size communications between client and remote sockets exponentially worsens as a remote web server increases its advertised window scale value. This inevitably results in poor utilization of the communication links and low throughput.

To demonstrate the advantages of the present, improved TCP Splice implementation over the prior art, FIG. 5 depicts the same hypothetical window scaling values as used in the prior art example above. In particular, a client socket of the client device 502 advertises a window scale value of 5 during its TCP handshake with the SOCKSv5 proxy service of the proxy device 500, and the remote web server 504 advertises a window scale value of 4 during its TCP handshake with the SOCKSv5 proxy service of the proxy device 500. With the addition of the window size splicer 322, the SOCKSv5 proxy device 500 is free to advertise its window scaling value allowable under RFC 7323. In this example, it is assumed that the SOCKSv5 proxy device 500 chooses to advertise a window scaling value of 7 to both the client 502 and remote web server 504 (as shown in FIG. 5).

Again, assume that a packet sourced from the socket of the remote server 504 is relayed by the proxy device 500 to the socket of the client device 502 that specifies the remote server's window size to be value 0x00a5. When the proxy device 500 receives the packet from the remote server socket, the window size splicer 322 first obtains the remote server socket's original intended window size by left shifting 0x00a5 (with the left shifter 330). In other words, 0x00a5<<4=0x0a50=2,640 bytes. Then that window size value of 0x0a50 is spliced by right shifting (with the right shifter 332) back what the proxy-window-scale advertiser (SOCKSv5 proxy device 500 in this example) advertised, which is a window scaling value of 7. In other words, 0x0a50>>7=0x0014.

At the client socket of the client device 502, upon receiving the packet with window size value of 0x0014, the client performs window scaling with the proxy device's advertised window scale value of 7 as per RFC 7323. This leads the client device 504 to “think” the actual window size of the remote web server socket is 0x0014<<7=0x0a00=2,560 bytes.

In contrast to the Maltz et al. prior art implementation, the present splice implementation results in a delta discrepancy of 2,640−2,560=80 bytes, while the approach taught by Maltz et al. results in a delta discrepancy of 2,640−165=2,475 bytes. In other words, following the approach taught by Maltz et al, the client device 502 would assume an almost full receive buffer at the remote web server 504 with a small window size of 165 bytes and will next send a smaller data payload while waiting a long RTT for the next ACK.

In contrast, the TCP splice module 220 operates with a better approximation of the remote web server's 504 true window size of 2,560 Bytes, and the client device 502 will send a larger data payload while waiting for the long RTT and ACK notification resulting in overall higher throughput and link utilization.

The implementation of the TCP splice module 220 (including implementations such as the implementation in FIG. 5 that supports SOCKSv5 protocol) outperforms prior implementations with respect to the cost of CPU utilization for throughput. This demonstrates a superior TCP splice implementation and utilization of links such as long term evolution (LTE) and Ethernet links, representing LFNs, that yields better modem performance for modem chipsets compared to other implementations supporting SOCKSv5 protocol.

The presently disclosed method is also much better for LFNs to yield high TCP throughput and performance by more accurately determining end-to-end window sizes rather than wasting an advertised window scaling of 0. Additionally, with the previous prior art example (utilizing the implementation taught by Maltz et al.) the spliced window size delta discrepancy worsens as a remote server socket advertises a higher window scaling value. The present implementation of TCP splice is a better approximation to what end-to-end window sizes should be rather than simply ignoring window sizes. The presently disclosed implementation of TCP splice outperforms the Maltz et al. implementation of TCP splice, and as a direct result better CPU utilization and throughput is observed.

### Graceful Closure of Sockets on FIN, RST TCP Spliced Sessions

Another aspect of the TCP splice module 220 is the closure notification module 224, which operates in connection with the socket closure module 228 to close sockets in response to an event (e.g., a finish (FIN) or reset (RST) notification). Prior art implementations do not disclose techniques for gracefully closing sockets after observing FIN or RST notifications, and it is not trivial to just call close( ) on the two TCP spliced socket file descriptors (corresponding to the two TCP connections). In particular, the FIN or RST packets have already taken the proxy kernel's relay data path to the client's and remote webserver's sockets; thus, client and remote webserver sockets shut down with no longer active TCP sessions after proxy relays the FIN or RST packets. Without the novel socket closure approach described herein, this results in the proxy server's sockets remaining in the FIN_WAIT2 state for a LINUX default average of 15 minutes before entering the CLOSED state because the proxy client and remote webserver have closed their corresponding TCP sessions and will never send a FIN back to the proxy server's sockets.

In the present embodiment, the closure notification module 224 and socket closure module 228 handle the closing of sockets by enabling the SO_LINGER option to timeout for 0 seconds on the SOCKSv5 proxy sockets, forcing the LINUX kernel network stack to transmit a RST on the already observed FIN or RST TCP spliced sessions during the close( ) system call, thus removing the need for proxy sockets to enter the FIN_WAIT2 state. One of ordinary skill in the art will appreciate, in view of this disclosure, that the SO_LINGER option is a socket option of the LINUX kernel. When enabled, a close(2) or shutdown(2) will not return until all queued messages for the socket have been successfully sent or the linger timeout has been reached. Otherwise, the call returns immediately and the closing is done in the background. When the socket is closed as part of exit(2), it always lingers in the background.

The benefit and advantage to properly cleaning up and closing sockets (after a spliced TCP session has relayed FIN or RST packets) is to ensure that there is freed memory available on an embedded system. Otherwise, improper cleaning and closing of sockets, waiting for FIN or RST on already dead TCP sessions in FIN_WAIT2 state, will continuously consume large amounts of memory and prohibit further SOCKSv5 support for multiple clients due to the inability to allocate additional sockets because of finite memory limitations.

Referring next to FIG. 7, shown is a block diagram depicting physical components that may be utilized to realize one or more aspects of the embodiments disclosed herein (e.g., embodiments of the remote server 104, proxy device 100, and client device 102). As shown, in this embodiment a display portion 712 and nonvolatile memory 720 are coupled to a bus 722 that is also coupled to random access memory (“RAM”) 724, a processing portion (which includes N processing components) 726, a field programmable gate array (FPGA) 727, and a transceiver component 728 that includes N transceivers. Although the components depicted in FIG. 3 represent physical components, FIG. 3 is not intended to be a detailed hardware diagram; thus many of the components depicted in FIG. 3 may be realized by common constructs or distributed among additional physical components. Moreover, it is contemplated that other existing and yet-to-be developed physical components and architectures may be utilized to implement the functional components described with reference to FIG. 7.

The display 712 generally operates to provide a user interface for a user. The display 712 may be realized, for example, by a liquid crystal display (LCD) or AMOLED display, and in several implementations, the display 712 is realized by a touchscreen display. In general, the nonvolatile memory 720 is non-transitory memory that functions to store (e.g., persistently store) data and processor executable code (including executable code that is associated with effectuating the methods described herein). In some embodiments for example, the nonvolatile memory 720 includes bootloader code, operating system code, file system code, and non-transitory processor-executable code to facilitate the execution of functional components depicted in FIGS. 1 and 2, and the methods described herein.

In many implementations, the nonvolatile memory 720 is realized by flash memory (e.g., NAND or ONENAND memory), but it is contemplated that other memory types may be utilized. Although it may be possible to execute the code from the nonvolatile memory 720, the executable code in the nonvolatile memory is typically loaded into RAM 724 and executed by one or more of the N processing components in the processing portion 726.

The N processing components in connection with RAM 724 generally operate to execute the instructions stored in nonvolatile memory 720 to enable the display of graphical content (and the deferred updating of graphical layers). For example, non-transitory processor-executable instructions to effectuate the methods described with reference to FIG. 4 may be persistently stored in nonvolatile memory 720 and executed by the N processing components in connection with RAM 724. As one of ordinarily skill in the art will appreciate, the processing portion 726 may include a video processor, digital signal processor (DSP), graphics processing unit (GPU), and other processing components.

The depicted transceiver component 728 includes N transceiver chains, which may be used for communicating with external devices via wireless or wireline networks. Each of the N transceiver chains may represent a transceiver associated with a particular communication scheme (e.g., Thernet, WiFi, CDMA, LTE, Bluetooth, NFC, etc.). The transceiver chains may be utilized to support the communications between devices disclosed herein. In many embodiments, the computing device 100 is a wireless computing device that utilizes wireless transceiver technology, but the computing device 100 may also be implemented using wireline technology.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

FIG. 7 depicts an example of constructs that may be utilized to implement embodiments disclosed herein, but the various illustrative logical blocks, modules, and circuits described in connection with the embodiments disclosed herein may be implemented or performed in a variety of different ways. For example, the various illustrative logical blocks, modules, and circuits described in connection with the embodiments disclosed herein (e.g., in FIGS. 2 and 3) may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, erasable programmable read-only memory (EPROM) memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A communication device comprising:
a first transceiver configured to communicate with a client device that advertises a client-window-scale value via a local area network;
a second transceiver configured to communicate with a remote server that advertises a server-window-scale value via a wide area network;
a proxy server application configured to initiate two secure TCP connections, the TCP connections including a first logical connection between the client device and the communication device and a second logical connection between the communication device and the remote server;
a TCP splice module configured to splice the two TCP connections and relay data between the client device and the remote server, the TCP splice module including:
a window scaling component configured to:
advertise a proxy-window-scale-value;
when receiving a client-sourced-packet from the client device:
left shift a window size of the client-sourced-packet by the client-window-scale value to obtain an originally intended client-window size;
right shift the originally intended client-window size by the proxy-window-scale-value; and
relay the client-source-packet to the server with the proxy-window scaled value; and
when receiving a server-sourced-packet from the remote server:
left shift a window size of the server-sourced-packet by the server-window-scale value to obtain an originally intended server-window size;
right shift the originally intended server-window size by the proxy-window-scale-value; and
relay the server-sourced-packet to the client with the proxy-window scaled value.

2. The communication device of claim 1, wherein the client device exposes an IPv6 address to the proxy server application, and the proxy server application is configured to expose a single IPv4 address to the remote server.

3. The communication device of claim 2, wherein the proxy server application is configured to initiate the two secure TCP connections according to a SOCKSv5 protocol.

4. The communication device of claim 1, wherein the first transceiver is configured to communicate with the client device via an ethernet connection, and the second transceiver is configured to communicate with the remote server via a long term evolution (LTE) connection.

5. The communication device of claim 1, including:
a socket closure module configured to operate in user space and prompt the proxy server app to close the two secure TCP connections;
wherein the TCP splice module resides in a kernel level and includes a closure notification module configured to send a closure notification signal the socket closure module in response to a FIN flag or an RST flag.

6. The communication device of claim 5, wherein TCP splice module is configured to operate within a LINUX kernel, and the closure notification module is configured to enable the SO_LINGER socket option to timeout for 0 seconds.

7. A method for connecting a client device and a remote server, the method including:
initiating, with a proxy server application, two secure TCP connections, the TCP connections including a first logical connection between the client device and the proxy server application and a second logical connection between the proxy server application and the remote server, and the TCP connections are spliced below a transport layer;
advertising, at the proxy service, a proxy-window-scale-value;
receiving a client-sourced-packet from the client device, the client device advertising a client-window-scale value:
left shifting a window size of the client-sourced-packet to obtain an originally intended client-window size;
right shifting the originally intended client-window size by the proxy-window-scale-value; and
relaying the client-sourced-packet to the server with the proxy-window scaled value; and
receiving a server-sourced-packet from the remote server;
left shifting a window size of the server-sourced-packet by the server-window-scale value to obtain an originally intended server-window size;
right shifting the originally intended server-window size by the proxy-window-scale-value; and
relaying the server-sourced-packet to the client with the proxy-window scaled value;
thereby providing a more accurate window size portrayal on both TCP sessions to enable higher throughput between the client and remote server.

8. The method of claim 7 including:
exposing a single IPv4 address to the remote server while the client device exposes an IPv6 address.

9. The method of claim 8, including initiating the two secure TCP connections with the proxy server application according to a SOCKSv5 protocol.

10. The method of claim 7, including:
initiating the first logical connection between the client device and the proxy server application via an Ethernet connection; and
initiating the second logical connection between the proxy server application and the remote server via a long term evolution (LTE) connection.

11. The method of claim 7, including:
initiating the two secure TCP connections in user space with the proxy server application;
splicing the two secure TCP connections at an IP-level in a kernel space;
sending a closure notification signal a socket closure module in user space in response to a FIN flag or an RST flag;
prompting, with the socket closure module, the proxy server application to close sockets of the two secure TCP connections.

12. The method of claim 11, including:
splicing the two secure TCP connections at an IP-level in a LINUX kernel; and
enabling a SO_LINGER socket option to timeout for 0 seconds to force the LINUX kernel to transmit a an RST on an already observed FIN or RST during a close( ) system call; thereby removing a need for proxy sockets to enter an FIN_WAIT2 state.

13. A non-transitory, tangible computer readable storage medium, encoded with processor readable instructions to perform a method for connecting a client device and a remote server, the method comprising:
initiating, with a proxy server application, two secure TCP connections, the TCP connections including a first logical connection between the client device and the proxy server application and a second logical connection between the proxy server application and the remote server, and the TCP connections are spliced below a transport layer;
advertising, at the proxy service, a proxy-window-scale-value;
receiving a client-sourced-packet from the client device, the client device advertising a client-window-scale value:
left shifting a window size of the client-sourced-packet to obtain an originally intended client-window size;
right shifting the originally intended client-window size by the proxy-window-scale-value; and
relaying the client-sourced-packet to the server with the proxy-window scaled value; and
receiving a server-sourced-packet from the remote server;
left shifting a window size of the server-sourced-packet by the server-window-scale value to obtain an originally intended server-window size;
right shifting the originally intended server-window size by the proxy-window-scale-value; and
relaying the server-sourced-packet to the client with the proxy-window scaled value;
thereby providing a more accurate window size portrayal on both TCP sessions to enable higher throughput between the client and remote server.

14. The non-transitory, tangible computer readable storage medium of claim 13, the method including exposing a single IPv4 address to the remote server while the client device exposes an IPv6 address.

15. The non-transitory, tangible computer readable storage medium of claim 14, the method including initiating the two secure TCP connections with the proxy server application according to a SOCKSv5 protocol.

16. The non-transitory, tangible computer readable storage medium of claim 13, the method including:
initiating the first logical connection between the client device and the proxy server application via an Ethernet connection; and
initiating the second logical connection between the proxy server application and the remote server via a long term evolution (LTE) connection.

17. The non-transitory, tangible computer readable storage medium of claim 16, the method including:
initiating the two secure TCP connections in user space with the proxy server application;
splicing the two secure TCP connections at an IP-level in a kernel space;
sending a closure notification signal a socket closure module in user space in response to a FIN flag or an RST flag;
prompting, with the socket closure module, the proxy server application to close sockets of the two secure TCP connections.

18. The non-transitory, tangible computer readable storage medium of claim 17, the method including:
splicing the two secure TCP connections at an IP-level in a LINUX kernel; and
enabling a SO_LINGER socket option to timeout for 0 seconds to force the LINUX kernel to transmit a an RST on an already observed FIN or RST during a close( ) system call; thereby removing a need for proxy sockets to enter an FIN_WAIT2 state.
